(19) United States
(12) Patent Application Publication
(10) Pub. No.: US 2011/0061223 A1
(43) Pub. Date: Mar. 17, 2011

(54) TRAILER HITCH TOOL AND METHOD

(76) Inventor: Charles William Cascio, Tolar, TX (US)

(21) Appl. No.: 12/818,455

(22) Filed: Jun. 18, 2010

Related U.S. Application Data
(60) Provisional application No. 61/242,431, filed on Sep. 15, 2009.

(51) Int. Cl. B25B 27/14; B23P 11/00

(52) U.S. Cl. 29/426.6; 29/267

(57) ABSTRACT

The tool is comprised of an elongated arm, a leg, a handle, and a plurality of prongs. The leg of the preferred embodiment is hingedly coupled to the arm such that the leg may be extended or folded. The handle is at one end of the arm and the prongs are at the other.

In the preferred embodiment the arm and leg are formed from tubing and have a telescoping arrangement. The arm is comprised of segments. At an end of segment is a handle. Segment is slideably coupled to segment at an opposite end of segment. Segment has an inside diameter slightly larger than an outside diameter of segment. The length of said arm may be adjusted to pre-determined settings by a retaining mechanism comprising a projection/detent system. In the preferred embodiment, segment has a leaf spring mounted projection that is received by detent in segment.

This application claims the benefit of U.S. provisional application Ser. No. 61/242,431, filed Sep. 15, 2009.

### 1. FIELD OF THE INVENTION

The present invention relates to a tool and method that allow a user to safely and easily couple and uncouple a conventional trailer hitch assembly without having to climb onto the towing vehicle.

### 2. DESCRIPTION OF THE PRIOR ART

Trailers are used to transport cargo and come in numerous configurations and capacities. One type of trailer is a gooseneck trailer. The conventional gooseneck trailer couples to a hitch ball positioned near the rear axle of a towing vehicle, such as a pickup truck. Thus, the tongue, or “gooseneck” arches over the rear portion of the vehicle and positions the weight of the trailer over the axle. This coupling arrangement offers advantages over bumper coupling arrangements. A gooseneck trailer, for example, is generally capable of carrying a greater load, is more stable, and has a tighter turning radius than a conventional bumper pulled trailer.

While the gooseneck trailer offers several advantages, a gooseneck trailer is sometimes more difficult to couple to the hitch ball than a bumper pulled trailer. Most conventional gooseneck trailers have coupling devices comprised of a pair of plates and a spring loaded locking pin. One or both plates may be moved so as to be in either an open position or closed position. When in the open position, the plates form a circular opening through which the hitch ball may be inserted. When the ball is so positioned, the plates may then be moved to the closed position. In this position, the circular opening becomes elliptical and too narrow for the circular head of the hitch ball to exit.

To ensure that the plates remain in this closed position while the trailer is being towed, a locking pin is inserted into an opening that passes through the plates. In order to properly position the plates, the user is required to climb onto the towing vehicle and manually move the locking pin. This activity takes time and occasionally results in injury.

What is needed is a device and method that allow a user to safely and easily couple and uncouple a gooseneck trailer without having to climb onto the towing vehicle.

### BRIEF DESCRIPTION OF THE DRAWINGS

FIG. 1 is a side plan view of a prior art conventional gooseneck trailer coupling mechanism.

FIG. 2 is a top side plan view of the trailer hitch tool in accordance with a preferred embodiment.

FIG. 3 is a side plan view of the trailer hitch tool with the leg in the extended position, in accordance with a preferred embodiment.

FIG. 4 is a top and side isometric view of the trailer hitch tool in accordance with a preferred embodiment.

FIG. 5 is a side plan view of the trailer hitch tool depicting the tool with the leg and arm in the stowed position, in accordance with a preferred embodiment.

FIG. 6 is a side plan view of the trailer hitch tool depicting the tool with the leg in the stowed position and alternative extended position, and the handle telescoped further towards the prongs in accordance with an alternative embodiment.

FIG. 7 is a top and side isometric view of the trailer hitch tool in position to be used to move the locking pin handle in accordance with a preferred embodiment.

### DESCRIPTION OF THE PREFERRED EMBODIMENT

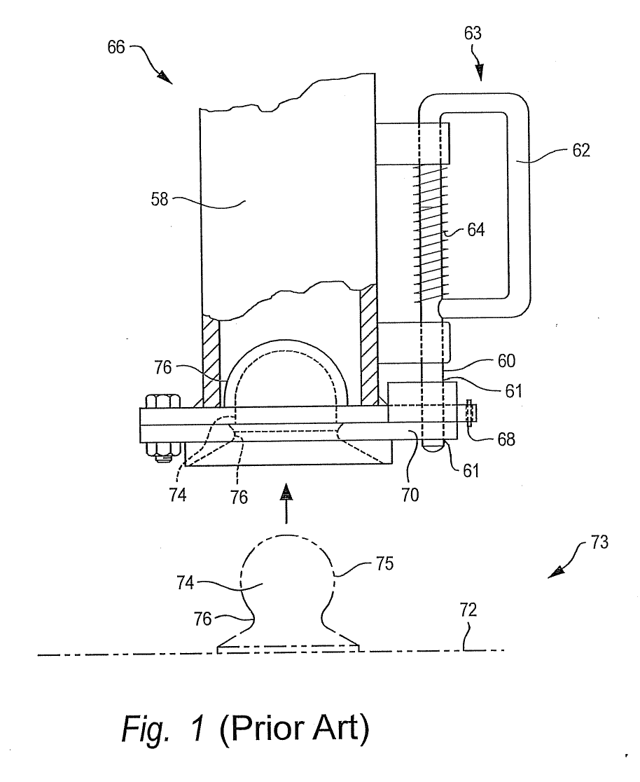

In FIG. 1, there is shown a conventional gooseneck hitch coupling assembly 66 that may be placed over a hitch ball 74 mounted on the surface 72 of a towing vehicle. The coupling assembly 66 is generally comprised of a housing 58, a hitch ball receptacle 76, a locking pin 60, a locking pin opening 61, a locking pin handle 62, a spring 64, a first plate 68, a second plate 70. A conventional hitch ball 74 is comprised of a ball head 75 and a narrow neck 76.

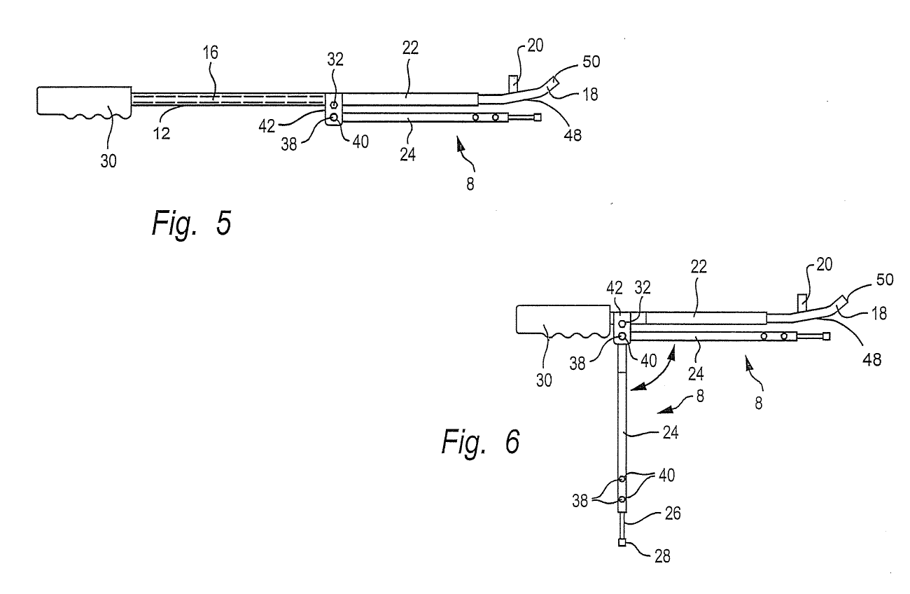

Referring to FIGS. 1-5, there is shown a trailer hitch tool 14 of the present invention, in accordance with a preferred embodiment, which may be used to position a coupling assembly 66 like or similar to that depicted in FIG. 1. The tool 14 is comprised of a handle 6, a rocking portion 8 and an engagement portion 10. In the preferred embodiment, the rocking portion 8 is comprised of an extension portion, or leg 24 (FIGS. 3-5), and the engagement portion 10 is comprised of a plurality of prongs 18, 20. The leg 24 of the preferred embodiment is hingedly coupled to a middle portion 36 such that the leg 24 may be extended, as shown in FIG. 3, or folded, as shown in FIG. 5. A gripping portion 30 is positioned on the handle 6.

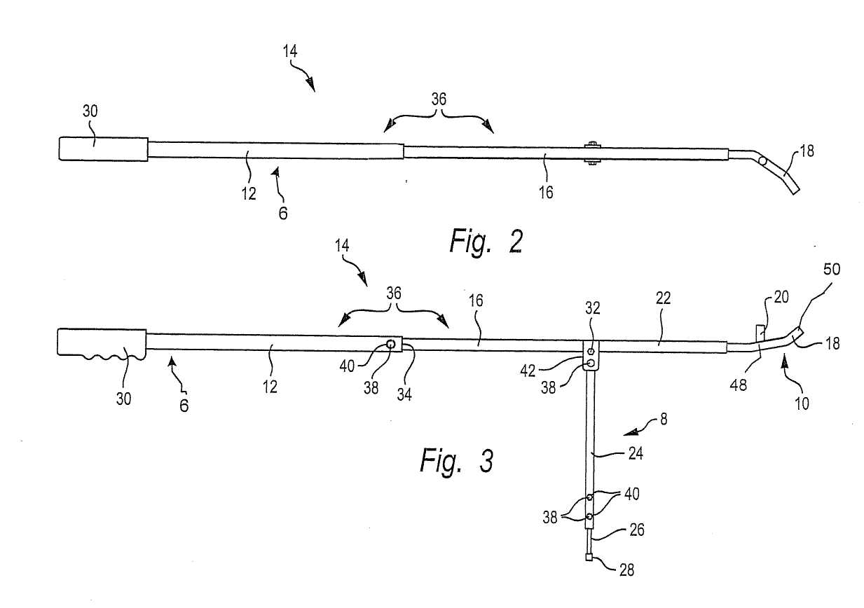

In the preferred embodiment, the tool 14 is formed from tubing and has a telescoping arrangement. Referring to FIGS. 2 and 3, the tool 14 is comprised of segments 12, 16, 22. At a proximal (closer to the user) end of segment 12 is the gripping portion 30. Segment 12 is slideably coupled to segment 16 at an opposite and of segment 12. Segment 12 has an inside diameter slightly larger than an outside diameter of segment 16. The length of the tool 14 may be adjusted to pre-determined settings by a retaining mechanism 34 comprising a projection/detent system 38, 40. In the preferred embodiment, segment 16 has a leaf spring mounted projection 38 that is received by detent 40 in segment 12. Therefore, segment 16 may be nested within segment 12 as shown in FIG. 5.

Referring to FIGS. 3 and 5, the rocking portion 8 is comprised of leg 24 and segment 26. Leg 24 has an inside diameter slightly larger than an outside diameter of segment 26. Therefore, segment 26 may be nested within leg 24. The length of said rocking portion 8 may be adjusted to pre-determined settings by a retaining mechanism comprising a projection/detent system 38, 40. In the preferred embodiment, segment 26 has a leaf spring mounted projection 38 that is received by detents 40 in leg 24.

Although the tool 14 of the preferred embodiment is constructed from tubular steel and has a telescopic arrangement, the tool 14 need not be so constructed. For example, the tool 14 may be formed from any suitable material such as polycarbonate, fiberglass, other metals, or other materials. The leg 25 and arm 36 also need not have a telescopic arrangement. Rather, the tool 14 may be formed from a single piece of material without departing from the spirit of the present invention.

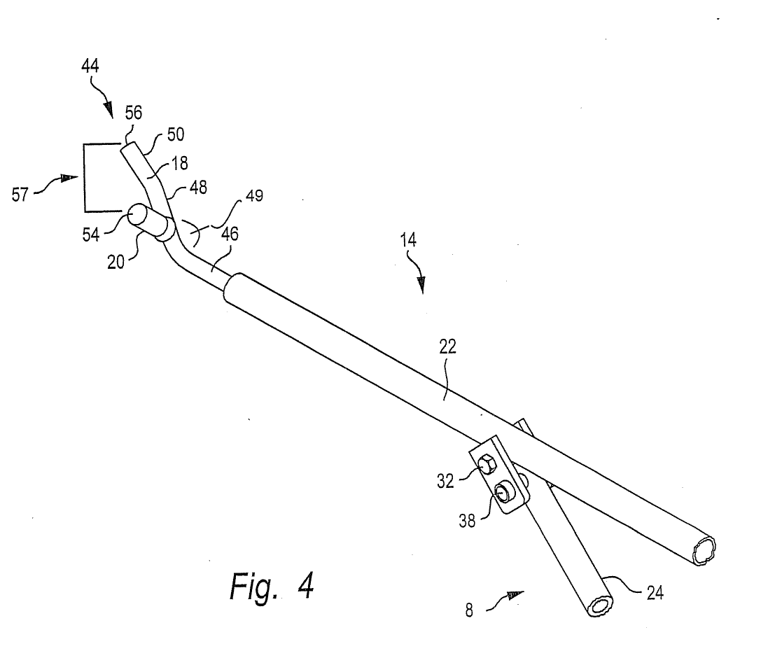

Referring to FIG. 3, rocking portion 8 is further comprised of a padded sleeve 28. This sleeve 28 extends over an end of segment 26 and is formed from rubber or similar slip resistant material and prevents the tool 14 from slipping when in use. In the preferred embodiment, leg 24 is hingedly coupled to the middle portion 36. Leg 24 rotates about pivot post 32 contained within hinge bracket 42 such that when in the extended position, said leg 24 is positioned at approximately a ninety degree angle to said middle portion 36. When in the folded position, as shown in FIG. 4, the leg 24 and middle portion 36 are approximately parallel to one another. The leg 24 and hinge bracket 42 are also comprised of a retaining mechanism comprised of a projection/detent system such that the leg 25 may be locked into position. In the preferred embodiment, leg 24 has a leaf spring mounted projection 38 that is received by detent 40 in the hinge bracket 42.

Referring to the figures and in particular to FIGS. 3-4, in a preferred embodiment of the present invention, the trailer hitch tool 14 is further comprised of the engagement portion 10. The engagement portion 10 extends from segment 22 and is comprised of a main prong 18 and a secondary prong 20.

Referring to FIGS. 3-4, the main prong 18 of the preferred embodiment is comprised of a base portion 46, an intermediate portion 48, and an end portion 50 (FIG. 3). The base portion 46 extends outwardly from, and along the longitudinal axis of segment 22. The intermediate portion 48 is offset and extends generally tangentially from base portion 46 such that, when viewed from the top, an angle 49 is formed between said base 46 and intermediate 48 portion. In the preferred embodiment, this angle 49 is approximately 45 degrees. The end portion 50 extends upward from the intermediate portion 48 when viewed from the side. As depicted in FIGS. 3, 5, & 6, the secondary prong 20 extends generally perpendicularly from the intermediate portion 48 of the main prong 18, when viewed from the side.

With the prongs 18, 20 so arranged, (FIG. 4) a main prong end 56 and secondary prong end 54 have a distance 57 between them. Thus, in the preferred embodiment, the main prong 18 and secondary prong 20 form a generally “U” shaped structure with the secondary prong 20 forming one side of the “U” and the main prong 18 forming the other.

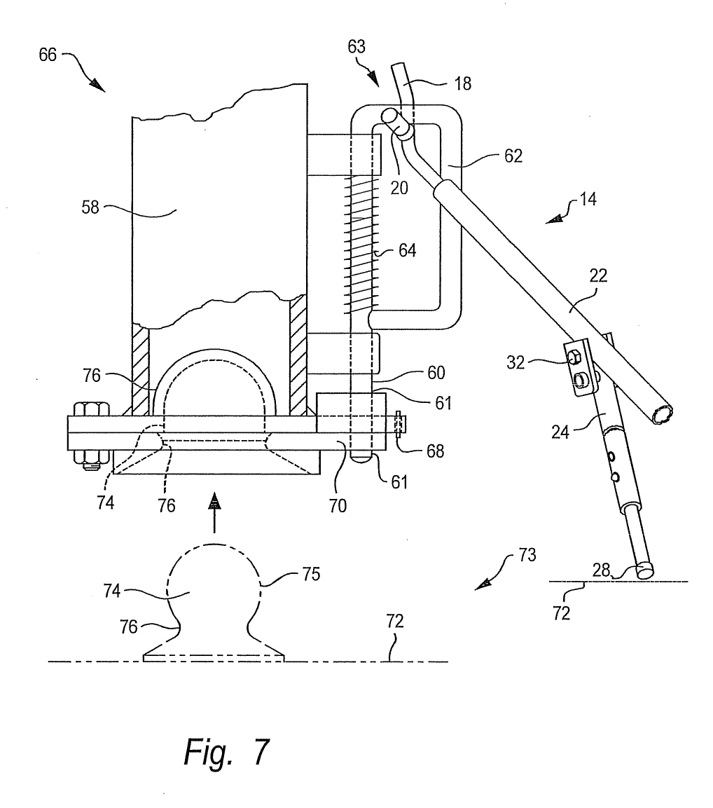

The prongs 18, 20 are structured and arranged to allow a user to move the locking pin handle 62 (FIG. 7) which, in turn, moves the locking pin 60. In the preferred embodiment, the prongs 18, 20 are arranged such that one prong 18 may be placed on one side of a portion of locking pin handle 62 and the one prong 20 on the other side of locking pin handle 62. In the preferred embodiment, the prongs 18, 20 are placed in the area 63 shown in FIGS. 1 and 7. While the prongs 18, 20 are in this position, the rocking portion 8, while in the extended position shown in FIG. 3 may be placed against the surface 72 of the tow vehicle (FIG. 7).

In FIG. 6 the trailer hitch tool 14 is shown in an alternative embodiment. In this embodiment, the middle portion 36 is telescoped further towards the prongs 18, 20 to provide a more compact storage configuration.

Referring to FIGS. 1 & 7, the operation and use of the tool 14 of the present invention will now be discussed. The user moves one or both of the plates 68, 70 so as to be in either a closed or open position (FIGS. 1 & 7). In the open position, an opening is present through which the ball head 75 may pass. In the closed position, an opening is present through which the ball neck 76 may move relatively freely, but through which the ball head 75 is incapable of passing.

Referring to FIG. 1, one of the plates 68 is directly or indirectly fixed to the locking pin handle 62 such that when the handle 62 is moved, there is corresponding movement of the plate 68. Therefore, the user can move the plate 68 by moving the handle 61 laterally. The handle 61 is also capable of being moved vertically such that, upon such movement, the locking pin 60 is moved vertically. Therefore, the user can concurrently move the plate 68 laterally and the pin 60 vertically.

Referring to FIG. 7, with the plates 68, 70 in the desired position, the user then places a portion of the locking pin handle 62 between the prongs 18, 20 and using the rocking portion 8 as a fulcrum, pivots the locking pin 60 to a desired position.

Referring to FIGS. 1 & 7, the present invention provides a method of preparing a gooseneck trailer coupler 66 for uncoupling from a hitch ball 74. This method comprises providing the tool 14, while standing on an exterior of a tow vehicle 73 having a gooseneck trailer 73 coupled to the hitch ball 74, and using the rocking portion 8 as a fulcrum, moving the locking pin handle 62 with the tool 14 so as to remove the locking pin 60 from the locking pin opening 61, moving a retaining plate 68, 70 to create an opening through which the ball 74 is capable of exiting.

Referring to FIGS. 1 & 7, the present invention provides a method of preparing a gooseneck trailer coupler 66 for coupling to a hitch ball 74. This method comprises providing the tool 14, while standing on an exterior of a tow vehicle 73 having a hitch ball 74 inserted within a gooseneck trailer 73 receptacle 76, moving a retaining plate 68, 70 to a closed position so as to create a narrow opening through which the ball 74 is incapable of exiting, while using the rocking portion 8 as a fulcrum, moving the locking pin handle 62 with the tool 14 so as to insert the pin 60 into the locking pin opening 61.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of this disclosure.

I claim:

1. A trailer hitch tool comprising:
a handle portion;
a rocking portion;
an engagement portion; and
wherein said rocking portion is positioned between said handle portion and said engagement portion.

2. The trailer hitch tool of claim 1 wherein said rocking portion extends outwardly from a middle portion of said tool.

3. The trailer hitch tool of claim 2 wherein said rocking portion is hingedly coupled to said middle portion.

4. The trailer hitch tool of claim 1 wherein said engagement portion is comprised of a plurality of prongs.

5. The trailer hitch tool of claim 1 wherein said tool has an adjustable length.

6. The trailer hitch tool of claim 4 wherein said tool has a telescopic arrangement.

7. The trailer hitch tool of claim 6 wherein said tool is further comprised of a projection and detent arrangement.

8. The trailer hitch tool of claim 1 wherein said handle portion is further comprised of a gripping portion.

9. The trailer hitch tool of claim 2 wherein said rocking portion has an adjustable length.

10. The trailer hitch tool of claim 9 wherein said rocking portion has a telescopic arrangement.

11. The trailer hitch tool of claim 2 wherein said rocking portion is comprised of a sleeve.

12. A tool for moving a trailer coupling mechanism comprised of a means for applying vertical and rotational force upon said mechanism.

13. A method of preparing a trailer coupler for uncoupling from a hitch ball comprising:
providing an elongated tool having a rocking portion and an engagement portion;
while using said rocking portion as a fulcrum, moving a locking pin handle with said engagement portion so as to remove a locking pin from a locking pin opening; and
moving a retaining plate to create an opening through which the hitch ball is capable of exiting.

14. A method of preparing a trailer coupler for coupling to a hitch ball comprising:
providing an elongated tool having rocking portion and an engagement portion;
moving a retaining plate to create an opening through which the hitch ball is incapable of escaping; and
while using the rocking portion as a fulcrum, moving a locking pin handle with said engagement portion so as to insert a locking pin into a locking pin opening.
